(19) United States
(12) Patent Application Publication
(10) Pub. No.: US 2026/0194169 A1
(43) Pub. Date: Jul. 9, 2026

(54) WATER PIPE JOINT AND WATER PIPE

(71) Applicant: Guixing ZHOU, Jinhua (CN)

(72) Inventor: Guixing ZHOU, Jinhua (CN)

(21) Appl. No.: 19/438,779

(22) Filed: Jan. 2, 2026

(30) Foreign Application Priority Data
Jan. 3, 2025 (CN) 202520015247.4
Dec. 24, 2025 (CN) 202522759788.0

(51) Int. Cl. F16L 27/08

(52) U.S. Cl. CPC F16L 27/0804

(57) ABSTRACT

A water pipe joint includes a first connecting member and a second connecting member. The technical solution of the present application sets relatively rotatable first connecting member and second connecting member, which are respectively connected to a water pipe and a faucet. During tightening, the first connecting member rotates relative to the second connecting member to prevent twisting of water pipes and other components and to reduce safety hazards. A void space is provided between the second connecting member and the water pipe connected to the first connecting member, thus preventing the rotation of the second connecting member from being affected by contact with the water pipe and ensuring the normal use of the water pipe joint.

### CROSS-REFERENCE TO RELATED APPLICATIONS

The present application claims priority to Chinese Patent Application No. 202520015247.4, filed on Jan. 3, 2025, and Chinese Patent Application No. 202522759788.0, filed on Dec. 24, 2025, the entire contents of which are incorporated herein by reference.

### TECHNICAL FIELD

The present application relates to the technical field of pipeline installation and structure, and in particular to a water pipe joint and a water pipe.

### BACKGROUND

Water pipes are widely used in practice, especially in the landscaping industry. Due to limitations such as the length of water pipes, they sometimes need to be used in conjunction with other equipment, such as water guns. The connecting parts between water pipes and other equipment, such as water guns, are water pipe joints. The design of the water pipe joints determines the convenience of connecting water pipes with other equipment.

In related art, when connecting water pipes to faucets, water guns, and other structures, threaded connections are mostly used. During the rotation connection of water pipe joints, issues such as looping or twisting can easily occur. As a result, the water pipe may rotate during water delivery, potentially causing a hazard.

### SUMMARY

The main purpose of the present application is to propose a water pipe joint and a water pipe, which aims to solve the problem of water pipes being entangled and knotted by torque due to existing threaded connection methods, thereby improving the convenience of connection and the safety of use.

To achieve the above-mentioned purposes, the water pipe joints proposed in the present application include:
a first connecting member; and
a second connecting member,
wherein the second connecting member passes through the first connecting member, and the first connecting member is rotatably connected to the second connecting member; and
the first connecting member is configured such that a water pipe is connected inside the first connecting member, and a void space is provided between the water pipe and the second connecting member.

In an embodiment, an inner peripheral wall of the first connecting member is provided with a first step, an outer peripheral wall of the second connecting member is provided with a second step, and the first step abuts against the second step.

In an embodiment, the inner peripheral wall of the first connecting member is further provided with a third step, the first step and the third step form a multi-level step structure, and the third step is configured such that the water pipe is connected inside the first connecting member and abuts against the third step.

In an embodiment, an outer peripheral surface of the second connecting member is provided with a plurality of first grooves surrounding the outer peripheral surface of the second connecting member, each first groove is provided with a seal ring, and the seal ring abuts against an inner peripheral wall of the first connecting member.

In an embodiment, a second groove is provided between two adjacent first grooves, a restricting member passes through the first connecting member, and a portion of the restricting member extends into the second groove.

In an embodiment, a vertical cross-section of the second groove is arc-shaped, and the portion of the restricting member extending into the second groove has a rounded end.

In an embodiment, a plurality of the restricting members are provided, the first connecting member is provided with a plurality of flat surfaces, and one restricting member passes through one flat surface.

In an embodiment, the second connecting member includes an axis core and a connection head, the axis core passes through the first connecting member with one end exposed from the first connecting member, the connection head is connected to the one end of the axis core, and a cross-sectional area of the connection head is greater than a cross-sectional area of the axis core.

In an embodiment, an outer peripheral surface of the connection head is provided with a plurality of limit portions arranged at intervals.

In an embodiment, the second connecting member includes an axis core and a connection head, the axis core is movably inserted into the first connecting member, and is provided with a connection section exposing from the first connecting member, and the connection section is connected to the connection head; and the first connecting member is provided with a connection portion at an end away from the connection head, and the connection head is configured to fixedly connect the water pipe.

In an embodiment, an outer peripheral wall of the axis core is provided with a second step, an inner peripheral wall of the first connecting member is provided with a first step matching the second step, and the second step abuts against the first step.

In an embodiment, an outer peripheral wall of the axis core is provided with a second step; an inner peripheral wall of the first connecting member is provided with a first step matching the second step; the first step and the second step are spaced apart to form a clearance space; and the clearance space is provided with a plurality of roller balls abutting against both the first step and the second step.

In an embodiment, the first step is provided with a limit groove communicated with the clearance space, and the roller balls are provided at the limit groove and are partially located in the clearance space.

In an embodiment, the water pipe joint further includes: a seal ring; wherein an outer peripheral wall of the axis core is provided with a first groove, and the seal ring is clamped in the first groove and abuts against an inner peripheral wall of the first connecting member.

In an embodiment, the water pipe joint further includes: a seal baffle; and a seal gap provided between a bottom wall of the connection section facing away from the first connecting member and the connection head, wherein the seal baffle is clamped in the seal gap.

In an embodiment, the first connecting member includes a plug-in member and a fix base fixedly connected to the plug-in member; an upper portion of the axis core is movably inserted into the plug-in member, and a lower portion of the axis core passes through the fix base to form the connection section; and an end of the plug-in member away from the fix base is provided with the connection portion, and the connection portion is an external thread.

In an embodiment, the connection portion is an internal thread.

In an embodiment, an outer peripheral surface of the connection head is provided with a fix portion and a limit portion; the fix portion is close to the first connecting member relative to the limit portion; and the fix portion is the external thread, and the limit portion includes a plurality of limit protrusions provided in sequence along a length direction of the connection head.

The present application also provides a water pipe, including the above-mentioned water pipe joint.

The technical solution of the present application sets up two relatively rotatable first connecting member and second connecting member. The first connecting member and the second connecting member are respectively connected to a water pipe and a faucet. During the tightening process, the first connecting member and the second connecting member rotate relative to each other, thereby preventing water pipes and other components from rotating and reduce potential safety hazards. At the same time, because there is a void space between the second connecting member and the water pipe connected in the first connecting member, the rotation of the second connecting member is not affected by contact between the second connecting member and the water pipe, thus ensuring the normal adaptation and use of the water pipe joint.

### BRIEF DESCRIPTION OF THE DRAWINGS

To more clearly illustrate the technical solutions in the embodiments of the present application or the related art, the drawings used in the description of the embodiments or the related art will be briefly introduced below. Obviously, the drawings described below are only some embodiments of the present application. For those skilled in the art, other drawings can be obtained based on the structures shown in these drawings without creative effort.

FIG. 1 is a schematic structural diagram of a water pipe joint according to an embodiment of the present application.

FIG. 2 is a schematic structural diagram of a water pipe joint according to another embodiment of the present application.

FIG. 3 is a schematic structural diagram of a water pipe joint according to another embodiment of the present application.

FIG. 4 is a schematic structural diagram of a water pipe joint according to another embodiment of the present application.

FIG. 5 is a schematic structural diagram of a water pipe joint according to another embodiment of the present application.

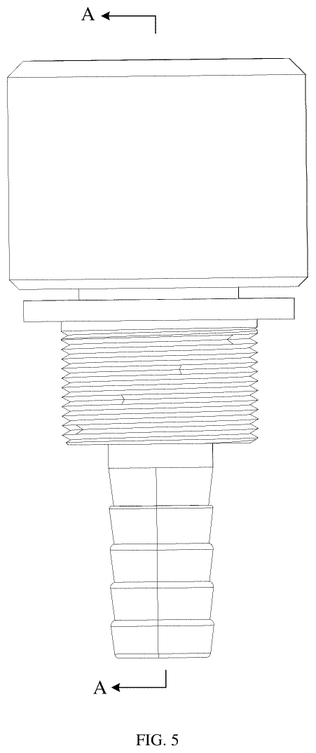

FIG. 6 is a cross-sectional view along line A-A in FIG. 5.

FIG. 7 is a schematic structural diagram of a water pipe joint according to another embodiment of the present application.

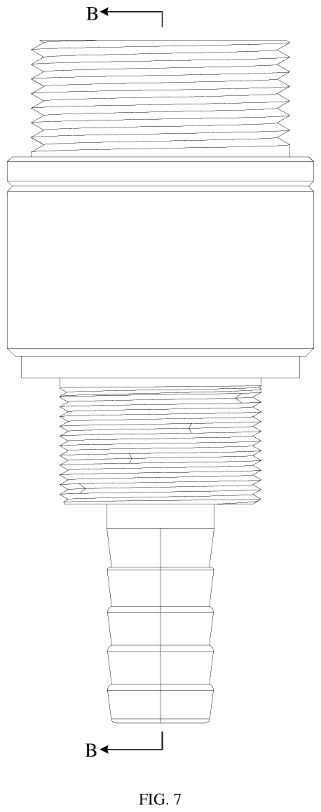

FIG. 8 is a cross-sectional view along line B-B in FIG. 7.

The realization of the purpose, functional features and advantages of the present application will be further explained in conjunction with the embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by persons skilled in the art without creative efforts are within the scope of protection of the present application.

It should be noted that if there are directional indications (such as up, down, left, right, front, back, etc.) involved in the embodiments of the utility model, these directional indications are only used to explain the relative positional relationships and movement conditions of various components in a specific orientation. If this specific orientation changes, the directional indications will correspondingly change accordingly.

In addition, if there are descriptions involving “first”, “second”, etc. in the embodiments of the present application, the descriptions of “first”, “second”, etc. are only for descriptive purposes and cannot be understood as indicating or implying their relative importance or implicitly indicating the number of technical features indicated. Therefore, the features limited to “first” and “second” can explicitly or implicitly include at least one of the features. In addition, if “and/or” appears in the full text, its meaning includes three parallel schemes. Taking “A and/or B” as an example, it includes scheme A, or scheme B, or schemes that A and B meet at the same time. In addition, the technical solutions between the various embodiments can be combined with each other, but it must be based on the ability of those skilled in the art to implement. When the combination of technical solutions is contradictory or cannot be implemented, it should be considered that such a combination of technical solutions does not exist and is not within the scope of protection required by the present application.

Water pipes are widely used in practice, especially in the landscaping industry. Due to limitations such as the length of water pipes, they sometimes need to be used in conjunction with other equipment, such as water guns. The connecting parts between water pipes and other equipment, such as water guns, are water pipe joints. The design of the water pipe joints determines the convenience of connecting water pipes with other equipment.

In related art, when connecting water pipes to faucets, water guns, and other structures, threaded connections are mostly used. During the rotation connection of water pipe joints, issues such as looping or twisting can easily occur. As a result, the water pipe may rotate during water delivery, potentially causing a hazard.

The present application proposes a water pipe joint.

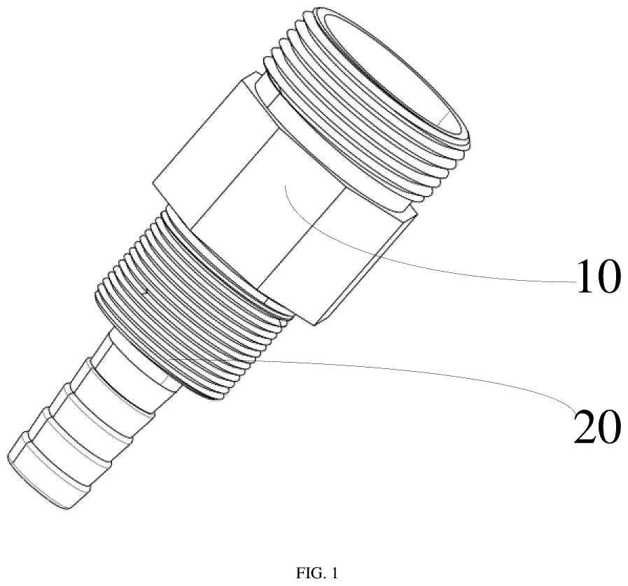

As shown in FIG. 1, in an embodiment of the present application, the water pipe joint includes a first connecting member 10 and a second connecting member 20.

The second connecting member 20 passes through the first connecting member 10, and the first connecting member 10 is rotatably connected to the second connecting member 20.

The first connecting member 10 is configured such that a water pipe is connected inside the first connecting member 10, and there is a void space between the water pipe and the second connecting member 20.

As shown in FIG. 1, the first connecting member 10 and the second connecting member 20 can be used to connect pipes, faucets, etc.

It is understandable that, as a connector between pipes or between a faucet and a pipe, the first connecting member 10 and the water pipe or faucet are mostly connected by rotation, and the second connecting member 20 and the water pipe or faucet are mostly connected by rotation. In order to avoid situations such as twisting during rotation, the first connecting member 10 and the second connecting member 20 are connected by rotation.

It is understandable that the first connecting member 10 and the second connecting member 20 can rotate relative to each other. That is, when the first connecting member 10 is fixed to the faucet or pipe and cannot rotate, the rotational cooperation between the second connecting member 20 and the water pipe or faucet can prevent the water pipe from twisting and reduce potential dangers when the second connecting member 20 rotates relative to the first connecting member 10.

It should be noted that the first connecting member 10 is connected to the pipe or faucet by a thread, and the second connecting member 20 is also connected to the pipe or faucet by a thread.

For this purpose, threaded portions are provided on the first connecting member 10 and/or the second connecting member 20.

In an embodiment, the threaded portion on the first connecting member 10 is provided on the outer surface of the first connecting member 10, so that the water pipe or faucet is directly sleeved on the first connecting member 10 and rotatably connected to the first connecting member 10.

In another embodiment, the threaded portion on the first connecting member 10 is disposed to abut against the inner peripheral wall of the first connecting member 10, thereby allowing a water pipe or faucet to pass through the first connecting member 10 and be threadedly connected to the first connecting member 10.

It should be noted that, in order to avoid the water pipe or faucet directly abutting against the second connecting member 20 after being connected to the first connecting member 10, thus affecting the rotation of the second connecting member 20 relative to the first connecting member 10, there is an void space between the water pipe or faucet and the second connecting member 20 after the water pipe or faucet is connected to the first connecting member 10.

Therefore, when the second connecting member 20 rotates relative to the first connecting member 10, the second connecting member 20 will not interfere with the first connecting member 10.

In another embodiment, the second connecting member 20 passes through the first connecting member 10, and a portion of the second connecting member 20 is exposed from the first connecting member 10.

It is understood that the second connecting member 20 exposed from the first connecting member 10 is provided with a threaded portion, which is provided on the outer peripheral surface or the inner peripheral wall of the second connecting member 20.

In another embodiment, the outer peripheral surface of the second connecting member 20 is provided with an interference fit portion. When a water pipe or the like is sleeved on the second connecting member 20, the water pipe is directly sleeved on the interference fit portion to prevent the water pipe from detaching from the second connecting member 20.

In order to enable water flow transmission after the water pipe joint is connected to the water pipe and faucet, the first connecting member 10 is provided with a first channel 13 that passes through the first connecting member 10, and the second connecting member 20 is provided with a second channel that passes through the second connecting member 20.

When the second connecting member 20 is inserted into the first connecting member 10, the first channel 13 is communicated with the second channel, thereby facilitating the flow of water along the water pipe through the first channel 13 and the second channel.

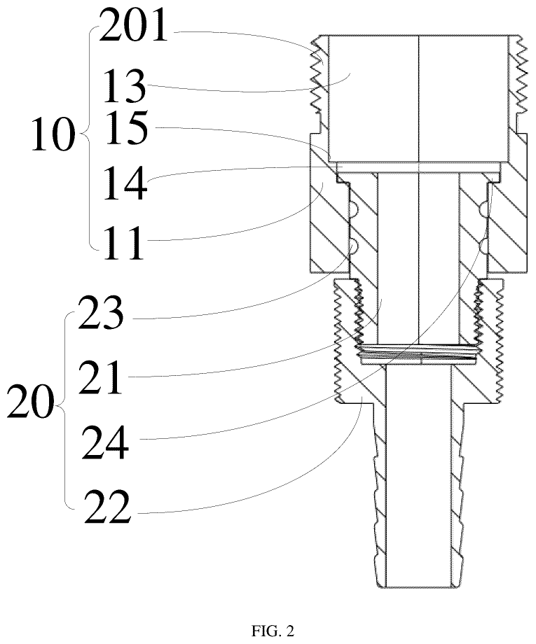

As shown in FIG. 2, the first connecting member 10 includes a connection body 11 and a connection portion 201. The connection body 11 has a connection portion 201 at the end of the connection body 11, which is used to connect a water pipe or a faucet, etc.

Furthermore, the connection portion 201 can be an external thread or an internal thread.

The technical solution of the present application sets up two relatively rotatable first connecting member 10 and second connecting member 20. The first connecting member 10 and the second connecting member 20 are respectively connected to water pipes and faucets. During the tightening process, the first connecting member 10 and the second connecting member 20 rotate relative to each other, thereby avoiding the appearance of twist on water pipes and reducing safety hazards. At the same time, because there is a void space between the second connecting member 20 and the water pipe connected in the first connecting member 10, the rotation of the second connecting member 20 is not affected by the contact between the second connecting member 20 and the water pipe, thereby ensuring the normal adaptation and use of the water pipe joint.

In an embodiment, the first connecting member 10 has a first step 14 on its inner peripheral wall and the second connecting member 20 has a second step 24 on its outer peripheral wall, with the first step 14 abutting against the second step 24.

As shown in FIG. 2, after the second connecting member 20 passes through the first connecting member 10, the first step 14 abuts against the second step 24.

Furthermore, a first step 14 is provided on the inner peripheral wall of the first channel 13, and a second step 24 is provided at the end of the second connecting member 20. After the second connecting member 20 passes through the first channel 13, the end of the second step 24 abuts against the first step 14.

It is understandable that the first step 14 and the second step 24 are used to prevent the second connecting member 20 from completely disengaging from the first connecting member 10 along its insertion direction.

It should be noted that, in order to avoid interfering with the rotation of the second connecting member 20 relative to the first connecting member 10, the step surface of the first step 14 is a plane, and the surface of the second step 24 that contacts the first step 14 is a plane.

Furthermore, the first step 14 is annular, and the second step 24 is also annular.

It is understandable that during the relative rotation of the first connecting member 10 and the second connecting member 20, the step surface of the first step 14 is a plane and the surface of the second step 24 in contact with the first step 14 is a plane, thereby ensuring the stability and smoothness of the relative rotation of the first connecting member 10 relative to the second connecting member 20.

In another embodiment, the vertical cross-section of the annular step surface of the first step 14 abutting the second step 24 is arc-shaped, and the vertical cross-section of the annular step surface of the second step 24 abutting the first step 14 is arc-shaped.

It is understandable that when the annular step surface of the first step 14 abuts against the annular step surface of the second step 24, the vertical cross section becomes arc-shaped, which improves the rotation efficiency of the second step 24 relative to the first step 14 and avoids the second connecting member 20 being restricted in its rotation relative to the first connecting member 10.

In an embodiment, the inner peripheral wall of the first connecting member 10 is further provided with a third step 15. The first step 14 and the third step 15 form a multi-level step structure. The third step 15 is configured such that the water pipe is connected inside the first connecting member 10 and abut against the third step 15. There is a void space between the water pipe and the second connecting member 20.

It should be noted that the first channel 13 is designed for inserting a water pipe or a faucet outlet. If only the first step 14 is provided, the water pipe or faucet may be of different lengths and may come into contact with the second step 24 located on the first step 14, thereby affecting the normal rotation of the second connecting member 20.

Therefore, based on the first step 14, a third step 15 is set in the direction away from the second step 24 of the first step 14.

It is understandable that when a water pipe or faucet is inserted into the first channel 13, the extreme position of the water pipe or faucet installed in the first connecting member 10 is the third step 15, that is, the third step 15 abuts against the water pipe or faucet.

That is, by means of a fixed spacing between the first step 14 and the second step 24, a void space is ensured between the water pipe or faucet and the second connecting member 20, thereby facilitating the rotation of the second connecting member 20 relative to the first connecting member 10.

In another embodiment, multiple protrusions are spaced apart inside the first channel 13, and the multiple protrusions are arranged on the same plane, so as to facilitate the restriction of water pipes or faucets connected in the first channel 13, thereby facilitating the reservation of void space.

In another embodiment, the first channel 13 is tapered to prevent water pipes or faucets from extending too far into the first channel 13.

In an embodiment, the outer peripheral surface of the second connecting member 20 is provided with a plurality of first grooves 30a surrounding the outer peripheral surface of the second connecting member 20, and a sealing ring 23 is provided in the first groove 30a, and the sealing ring 23 abuts against the inner peripheral wall of the first connecting member 10.

Because the connection structure formed by the second connecting member 20 and the first connecting member 10 is for connecting pipes or pipes and faucets and is required for water flow, it is necessary to seal the connection between the second connecting member 20 and the first connecting member 10.

Therefore, a sealing ring 23 is provided on the outer peripheral surface of the second connecting member 20, and the sealing ring 23 abuts against the inner peripheral wall of the first connecting member 10.

Understandably, the sealing ring 23 is designed to prevent water leakage from the gap between the first connecting member 10 and the second connecting member 20 in the direction of water flow, thereby ensuring safety during use.

Furthermore, in order to improve the sealing effect, multiple sealing rings 23 are provided in the extending direction of the second connecting member 20. The sealing of multiple sealing rings 23 prevents the possibility of leakage of liquids such as water through gaps.

Meanwhile, in order to avoid excessive gap between the first connecting member 10 and the second connecting member 20 due to the sealing ring 23 when the first connecting member 10 is connected to the second connecting member 20. A first groove 30a is provided on the inner peripheral wall of the second connecting member 20 to accommodate the sealing ring 23, and The opening of the first groove 30a is oriented towards the first connecting member 10..

Thus, after the first connecting member 10 and the second connecting member 20 are assembled, the sealing ring 23 abuts against the first connecting member 10 and the second connecting member 20. This avoids the gap between the first connecting member 10 and the second connecting member 20 being too large, which would affect the sealing effect of the sealing ring 23.

In another embodiment, a first groove 30a is provided on the inner peripheral wall of the first connecting member 10, and a sealing ring 23 is disposed in the first groove 30a and abuts against the second connecting member 20.

In another embodiment, the inner peripheral wall of the first connecting member 10 and the outer peripheral wall of the second connecting member 20 are both provided with a first groove 30a, and the first groove 30a on the first connecting member 10 and the first groove 30a on the second connecting member 20 are arranged opposite to each other. The two first grooves 30a located on the same plane surround and form a sealing space, and the sealing ring 23 is disposed in the sealing space.

It should be noted that the material of the sealing ring 23 has high wear resistance, so as to avoid the sealing effect being affected by the rotation of the second connecting member 20 relative to the first connecting member 10.

In an embodiment, a second groove 25 is provided between two adjacent first grooves 30a, and a restricting member is provided on the first connecting member 10, with a portion of the restricting member passing through the second groove 25.

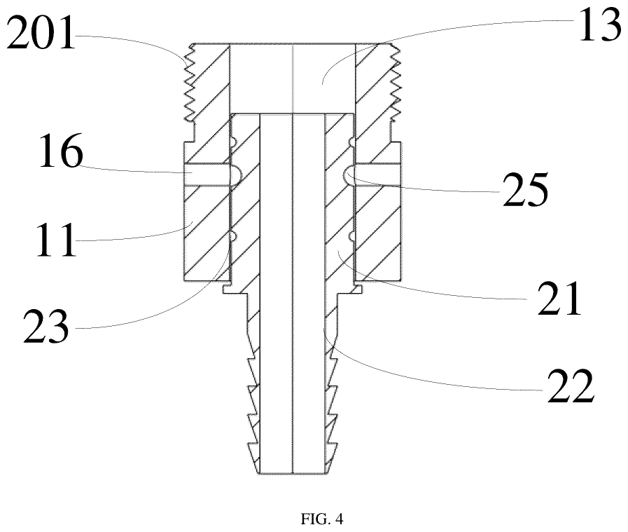

As shown in FIG. 4, the limiting fit between the first connecting member 10 and the second connecting member 20 can also be achieved by passing through a restricting member, and the insertion direction of the restricting member is set at an angle to the insertion direction of the second connecting member 20 relative to the first connecting member 10.

It is understandable that after the second connecting member 20 is inserted into the first connecting member 10, a restricting member is provided to restrict the second connecting member 20 from detaching from the first connecting member 10.

In order to avoid the restricting member affecting the relative rotation of the second connecting member 20 relative to the first connecting member 10, a second groove 25 is provided at the position where the second connecting member 20 connects to the restricting member, and the second groove 25 surrounds the surface of the second connecting member 20.

It is understandable that when the second connecting member 20 rotates relative to the first connecting member 10, the second groove 25 causes the restricting member to slide within the second groove 25, thereby enabling the restricting member to both restrict the relative movement between the second connecting member 20 and the first connecting member 10 and avoid interfering with the rotation between the second connecting member 20 and the first connecting member 10.

Because the restricting member is inserted through the first connecting member 10, the gap between the first connecting member 10 and the second connecting member 20 is communicated with the gap between the restricting member and the first connecting member 10, which can easily lead to liquid leakage.

Therefore, a second groove 25 is provided between two adjacent first grooves 30a. By providing two adjacent sealing rings 23, two sealing isolations are provided in the gap between the first connecting member 10 and the second connecting member 20, thereby preventing liquid from leaking between the restricting member and the first connecting member 10.

In an embodiment, in the extending direction of the second connecting member 20, a plurality of first grooves 30a are provided on both sides of the second groove 25, and a sealing ring is provided in each first groove 30a. Through multiple sealing isolations, liquid leakage is prevented from the second groove 25 and the gap between the restricting member and the first connecting member 10.

In an embodiment, the vertical cross-section of the second groove 25 is arc-shaped, and the restricting member extending into the second groove has a rounded end.

As shown in FIG. 4, the side of the second groove 25 facing away from the first connecting member 10 is arc-shaped, and the restricting member extending into the second groove 25 is provided with an arc surface.

It should be noted that when the restricting member is inserted into the second groove 25, the restricting member inserted into the second groove 25 may easily come into contact with the side wall of the second groove 25 during use, and thus may affect the rotation of the second connecting member 20 due to the restricting member.

It is understandable that the restricting member is provided with an arc surface, and the side of the second groove 25 facing away from the first connecting member 10 is arc-shaped, so that when the restricting member contacts the arc-shaped side of the second groove 25, the arc surface of the restricting member can not affect the rotation of the second connecting member 20, and reduce the restriction on the rotation of the second connecting member 20.

In an embodiment, multiple restricting members are provided, and multiple planes are provided on the first connecting member 10. One restricting member passes through one plane, and a portion of the restricting member extends into the second groove 25.

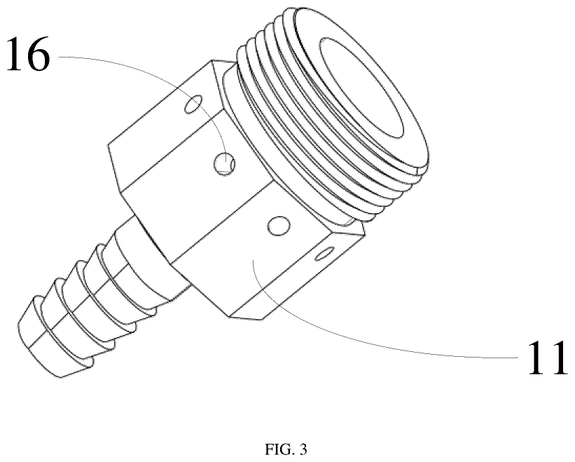

As shown in FIG. 3, the surface of the first connecting member for installing the restricting members is flat, and multiple restricting members are arranged around the first connecting member, so that the portion of the first connecting member 10 connecting the restricting members is polygonal.

Understandably, a flat surface for mounting the restricting member is provided on the first connecting member 10. In this way, when the restricting member is inserted into the first connecting member 10, the end of the restricting member can form a stable surface contact with the first connecting member 10, thereby improving the stability of the connection between the restricting member and the first connecting member 10.

In another embodiment, a connection hole 16 is provided on the flat surface of the first connecting member 10, the connection hole 16 passes through the first connecting member 10, and the connection hole 16 communicates with the first channel 13.

It is understandable that the restricting member passes through the connection hole 16 and extends into the second groove 25, so as to facilitate the restricting member in restricting the second connecting member 20.

Furthermore, the connection hole 16 has threads on its wall and the restricting member has threads on its side, so that the restricting member can be fixed on the first connecting member 10 by rotation assembly.

In another embodiment, the restricting member may be interference-fitted with the connection hole 16.

In an embodiment, the second connecting member 20 includes an axis core 21 and a connection head 22. The axis core 21 passes through the first connecting member 10 and one end of the axis core 21 is exposed from the first connecting member 10. The connection head 22 is connected to one end of the axis core 21, and the cross-section of the connection head 22 is larger than the cross-section of the axis core 21.

As shown in FIG. 2, the axis core 21 is disposed inside the first connecting member 10 and partially extends out of the first connecting member 10, and the connection head 22 is connected to the end of the axis core 21 that extends out of the first connecting member 10.

It is understood that a water pipe or faucet is connected to the first connecting member 10, and the connection head 22 can also be connected to a water pipe or faucet. The axis core 21 rotates relative to the first connecting member 10, thereby facilitating the rotational assembly of the first connecting member 10 and the connection head 22.

Meanwhile, in order to prevent the axis core 21 and the connection head 22 mounted on the first connecting member 10 from moving relative to the first connecting member 10 and affecting the stability of the connection. The cross-section of the connection head 22 is larger than that of the axis core 21. Therefore, when the connection head 22 is installed on the axis core 21, the connection head 22 and the axis core 21 form a stepped shape. This, in turn, restricts the position of the axis core 21 under the constraint of the connection head 22, and, in conjunction with the second step 24 on the axis core 21, prevents the installed axis core 21 from detaching from the first connecting member 10.

In an embodiment, the connection head 22 has a plurality of limit portions 12 arranged at intervals on its outer peripheral surface.

As shown in FIG. 1, the limit portions 12 are arranged at intervals on the connection head 22 to facilitate the insertion and fitting of water pipes, etc., and to ensure the stability of the insertion and fitting.

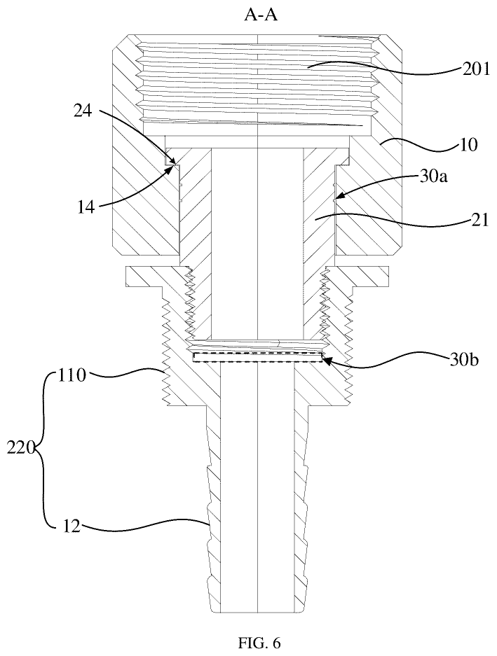

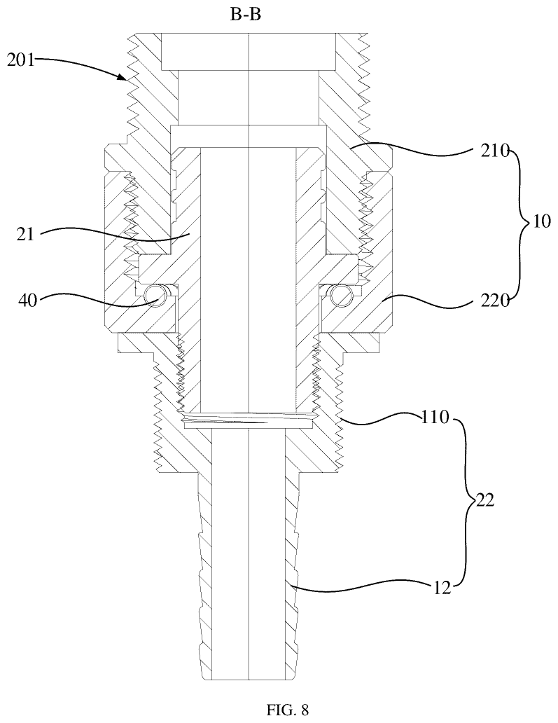

Please refer to FIGS. 6 and 8. The water pipe joint includes a connection head 22, a first connecting member 10, and an axis core 21. The axis core 21 is movably inserted into the first connecting member 10 and is provided with a connection section that exposes the first connecting member 10. The connection section connects to the connection head 22. One end of the first connecting member 10, which is away from the connection head 22, is provided with a connection portion 201. The connection head 22 is configured to fixedly connect a water pipe.

In the technical solution of the present application, the water pipe joint is used to connect the water pipe with a faucet, a water gun and other structures. The connection head 22 of the water pipe joint is used to insert the end of the water pipe, and the first connecting member 10 is used to connect the faucet, the water gun and other structures. When the axis core 21 is connected with the connection head 22 by rotation, because the axis core 21 is in a rotatable state in the first connecting member 10, when the water pipe is connected with the faucet, the water gun and other structures, the torque generated can be offset by the axis core 21, thereby avoiding the problem of the water pipe being circled or even knotted due to the torque.

It is understandable that the water pipe joint proposed in the present application can be used as a male joint or a female joint. When the water pipe joint is a male joint, the connection portion 201 is an external thread, which can be used to connect a structure with an internal thread, such as a water gun; when the water pipe joint is a female joint, the connection portion 201 is an internal thread, which can be used to connect a structure with an external thread, such as a faucet. Furthermore, whether it is used as a male joint or a female joint, the water pipe joint is provided with an axis core 21. When the water pipe joint connects the water pipe and the external structure, the rotatable axis core 21 is used to offset the torque generated by the installation, thereby avoiding knotting of the water pipe. Specifically, the connection head 22, the first connecting member 10 and the axis core 21 are all hollow structures, and the three together constitute a water passage to achieve water circulation. The axis core 21 partially passes through the first connecting member 10 to form a connection section that exposes the first connecting member 10, and the connection section is fixedly inserted into the connection head 22 through a threaded structure. Taking the female joint as an example, the connection head 22 is first fixedly inserted into the water pipe, the first connecting member 10 is connected to the faucet. Then the connection head 22 and the connection section are aligned, and the upper part of the connection head 22 is screwed into the lower part of the connection section through the threaded structure. In this process, because the axis core 21 is rotatable, the torque is offset. Alternatively, when the water pipe joint is assembled, the connection head 22 is fixedly inserted into the water pipe. Because the axis core 21 and the connection head 22 are movable through the threaded structure, and the first connecting member 10 is movable relative to the axis core 21, during the process of the first connecting member 10 being screwed into the faucet, the torque generated is not enough to rotate the axis core 21, so that the first connecting member 10 can offset the torque.

In an embodiment, please refer to FIG. 6, the outer peripheral wall of the axis core 21 is provided with a second step 24, and the inner peripheral wall of the first connecting member 10 is provided with a first step 14 matching the second step 24. At this time, the water pipe joint is a female joint. When the axis core 21 is inserted into the first connecting member 10, the second step 24 abuts against the first step 14, thereby realizing the positioning of the axis core 21. Furthermore, the second step 24 is uniformly raised along the outer peripheral wall of the axis core 21 to form an annular structure. In this way, the second step 24 can abut against the inner peripheral wall of the first connecting member 10 at 360°, thereby preventing the axis core 21 from being eccentric in the first connecting member 10.

In another embodiment, please refer to FIG. 8, the outer peripheral wall of the axis core 21 is provided with a second step 24, and the inner peripheral wall of the first connecting member 10 is provided with a first step 14 matching the second step 24. The second step 24 and the first step 14 are arranged at intervals to form a clearance space, and the clearance space is provided with a plurality of roller balls 40. The roller balls 40 abut against the second step 24 and the first step 14. In this case, the water pipe joint is a male joint, and when the axis core 21 is inserted into the first connecting member 10, the second step 24 abuts against the roller balls 40. In this way, the contact area between the axis core 21 and the first connecting member 10 can be reduced by the roller balls 40, and the axis core 21 is easy to rotate.

Further, referring to FIG. 6 and FIG. 8, in order to prevent the roller balls 40 from “running” in the first connecting member 10, the first step 14 is provided with a limit groove, and the limit groove is connected to the clearance space. The ball 40 is provided in the limit groove and is partially located in the clearance space. A plurality of roller balls 40 are clamped together in the limit groove, so as to achieve the limit fixation of the roller balls 40.

In an embodiment of the present application, the water pipe joint further includes a seal ring 23. The outer peripheral wall of the axis core 21 is provided with a first groove 30a, and the seal ring 23 is clamped in the first groove 30a and abuts against the inner peripheral wall of the first connecting member 10. The first groove 30a can be provided above or below the second step 24, which is not limited here. The seal ring 23 can block the gap between the inner peripheral wall of the first connecting member 10 and the outer peripheral wall of the axis core 21 to prevent water from leaking out of the water pipe joint.

Furthermore, the water pipe joint also includes a seal baffle. The seal baffle is an annular structure with a hollow center to ensure that the water passage is not blocked, thereby reducing the area of the flow cross section, and ensure that the water can flow smoothly from the faucet to the water outlet device. A seal gap 30b is provided between the bottom wall of the connection section facing away from the first connecting member 10 and the connection head 22, and the seal baffle is clamped in the seal gap 30b.

In an embodiment, please refer to FIG. 8, when the water pipe joint is a male joint, the first connecting member 10 includes a plug-in member 210 and a fix base 220. The upper part of the axis core 21 is movably inserted into the plug-in member 210, the fix base 220 is fixedly connected to the plug-in member 210, and the lower part of the axis core 21 passes through the fix base 220 to form a connection section. The inner peripheral wall of the fix base 220 is provided with an internal thread, and the outer peripheral wall of the plug-in member 210 is provided with an external thread, and the internal and external threads are connected to achieve a fixed connection between the plug-in member 210 and the fix base 220. The fix base 220 forms the first step 14, and the second step 24 of the axis core 21 is located between the bottom of the plug-in member 210 and the roller balls 40, so as to enable the axis core 21 to move. The end of the plug-in member 210 away from the fix base 220 is provided with a connection portion 201, and the connection portion 201 is an external thread.

In another embodiment, referring to FIG. 6, when the water pipe joint is a female joint, the connection portion 201 is an internal thread.

Further, please refer to FIGS. 6 and 8. The outer peripheral surface of the connection head 22 is provided with a fix portion 110 and a limit portion 12. The fix portion 110 is arranged close to the first connecting member 10 relative to the limit portion 12, and the fix portion 110 is an external thread. The limit portion 12 includes a plurality of limit protrusions provided in sequence along the length direction of the connection head 22, and the cross-section of each limit protrusion gradually decreases along the direction from close to the axis core 21 to away from the axis core 21, so that the outer peripheral surface of the limit protrusion is a conical surface, and each two adjacent limit protrusions form a limit step. In this way, the connection head 22 can be inserted into the water pipe and can play a role in preventing it from being pulled out, thereby preventing the connection head 22 from being flushed out under the action of water pressure. The fix portion 110 can be configured to connect the protection sleeve on the water pipe. When using the water pipe to flush, the protection sleeve can be held by hand to improve the grip.

The present application also provides a water pipe, which includes a pipe body and a water pipe joint. Part of the structure of the plug joint 10 is inserted into the end of the pipe body and fixedly connected to the inner wall of the pipe body. The pipe body is covered with a protection sleeve, which is fixedly connected to the connection head 22. The specific structure of the water pipe joint refers to the above embodiments. Since the water pipe proposed by the present application adopts all the technical solutions of the above embodiments, it has at least all the beneficial effects brought by the technical solutions of the above embodiments, which will not be repeated here.

The present application also proposes a water pipe, which includes a water pipe joint. The specific structure of the water pipe joint is as described in the above embodiments. Since this water pipe adopts all the technical solutions of all the above embodiments, it has at least all the beneficial effects brought about by the technical solutions of the above embodiments, which will not be described in detail here.

The above description is merely an exemplary embodiment of the present application and does not limit the scope of protection of the present application. Any equivalent structural transformations made based on the technical concept of the present application and the contents of the specification and drawings of the present application, or direct/indirect applications in other related technical fields, are included within the scope of protection of the present application.

What is claimed is:

1. A water pipe joint, comprising:
a first connecting member; and
a second connecting member,
wherein the second connecting member passes through the first connecting member, and the first connecting member is rotatably connected to the second connecting member; and
the first connecting member is configured such that a water pipe is connected inside the first connecting member, and a void space is provided between the water pipe and the second connecting member.

2. The water pipe joint according to claim 1, wherein an inner peripheral wall of the first connecting member is provided with a first step, an outer peripheral wall of the second connecting member is provided with a second step, and the first step abuts against the second step.

3. The water pipe joint according to claim 2, wherein the inner peripheral wall of the first connecting member is further provided with a third step, the first step and the third step form a multi-level step structure, and the third step is configured such that the water pipe is connected inside the first connecting member and abuts against the third step.

4. The water pipe joint according to claim 1, wherein an outer peripheral surface of the second connecting member is provided with a plurality of first grooves surrounding the outer peripheral surface of the second connecting member, each first groove is provided with a seal ring, and the seal ring abuts against an inner peripheral wall of the first connecting member.

5. The water pipe joint according to claim 4, wherein a second groove is provided between two adjacent first grooves, a restricting member passes through the first connecting member, and a portion of the restricting member extends into the second groove.

6. The water pipe joint according to claim 5, wherein a vertical cross-section of the second groove is arc-shaped, and the portion of the restricting member extending into the second groove has a rounded end.

7. The water pipe joint according to claim 5, wherein a plurality of the restricting members are provided, the first connecting member is provided with a plurality of flat surfaces, and one restricting member passes through one flat surface.

8. The water pipe joint according to claim 1, wherein the second connecting member comprises an axis core and a connection head, the axis core passes through the first connecting member with one end exposed from the first connecting member, the connection head is connected to the one end of the axis core, and a cross-sectional area of the connection head is greater than a cross-sectional area of the axis core.

9. The water pipe joint according to claim 8, wherein an outer peripheral surface of the connection head is provided with a plurality of limit portions arranged at intervals.

10. The water pipe joint according to claim 1, wherein the second connecting member comprises an axis core and a connection head, the axis core is movably inserted into the first connecting member, and is provided with a connection section exposing from the first connecting member, and the connection section is connected to the connection head; and the first connecting member is provided with a connection portion at an end away from the connection head, and the connection head is configured to fixedly connect the water pipe.

11. The water pipe joint according to claim 10, wherein an outer peripheral wall of the axis core is provided with a second step, an inner peripheral wall of the first connecting member is provided with a first step matching the second step, and the second step abuts against the first step.

12. The water pipe joint according to claim 10, wherein:
an outer peripheral wall of the axis core is provided with a second step;
an inner peripheral wall of the first connecting member is provided with a first step matching the second step;
the first step and the second step are spaced apart to form a clearance space; and
the clearance space is provided with a plurality of roller balls abutting against both the first step and the second step.

13. The water pipe joint according to claim 12, wherein the first step is provided with a limit groove communicated with the clearance space, and the roller balls are provided at the limit groove and are partially located in the clearance space.

14. The water pipe joint according to claim 10, further comprising:
a seal ring;
wherein an outer peripheral wall of the axis core is provided with a first groove, and the seal ring is clamped in the first groove and abuts against an inner peripheral wall of the first connecting member.

15. The water pipe joint according to claim 14, further comprising:
a seal baffle; and
a seal gap provided between a bottom wall of the connection section facing away from the first connecting member and the connection head,
wherein the seal baffle is clamped in the seal gap.

16. The water pipe joint according to claim 10, wherein:
the first connecting member comprises a plug-in member and a fix base fixedly connected to the plug-in member;
an upper portion of the axis core is movably inserted into the plug-in member, and a lower portion of the axis core passes through the fix base to form the connection section; and
an end of the plug-in member away from the fix base is provided with the connection portion, and the connection portion is an external thread.

17. The water pipe joint according to claim 10, wherein the connection portion is an internal thread.

18. The water pipe joint according to claim 16, wherein:
an outer peripheral surface of the connection head is provided with a fix portion and a limit portion;
the fix portion is close to the first connecting member relative to the limit portion; and
the fix portion is the external thread, and the limit portion comprises a plurality of limit protrusions provided in sequence along a length direction of the connection head.

19. A water pipe, comprising the water pipe joint according to claim 1.
